SEQUENCE LISTING (6 sequences)

SEQ ID NO: 1 - protein, 183 aa, Chromobacterium subtsugae
MSLTTDFLENPQAFMRSQAILIPAQVPPGNGKYQFAAQGAHAAVLQSTAASPNIPGFYAHPVANNINLFVLPTQQPARYYMFTDGMNGCQFLAYGPDRQHITVEHNNFIGDPTRYAARLAEVVALKPAYLLHISPSGVNNIPAGQYNSQQGVNIVGEYGQANGWRFWVRDRVDQNQGTVYGPL

SEQ ID NO: 2 - protein, 364 aa, Chromobacterium subtsugae
MDKRLPAVAAALLLAASAAHAGDLQVSLGQPVVSAGQDVDVALTYRNTGKETLHVYRWFVPGKELQEQFLAVNVNGKPAEYLGPRYKRVVPSLRDTVALAPGATLNAKVRVSEYYDLSKPGQLSVRFESSSNKVLNRSLPAGVNAKQAAAPQADEAISSNVVGAYSAGSVSPLLTKSKAAKQEWQVLSRSAVSGVSYAGNCSVSQQSQSRDGVLAASAMASETAAYLAGTPSGTPRFTTWFGKYSQANWTTAKSHYVNIKDALDSKPIKLDCSCTDGGTYAYVYPGQPYTVYLCGAFWTAPTKGTDSKGGTLVHELSHFTVVAGTQDHVYGQAGAKSLAKSNPAQALDNADNHEYFAENTPAQQ

SEQ ID NO: 3 - protein, 489 aa, Chromobacterium subtsugae
MRKQQLMLRGLVLSALAVFSSAALAAERIDLEKLGKIQANGAVAFTGVNQADLKPLRSTQFATGKVVTRFQQYYQGVPVWGEAVVEEKQAGAVAKTSGKLSGQYIAGIQSDLASAKPTLSSAQALSQAKSLKANGNPTYNEKADLVVRLNERNTAQLVYLVSFVVDGKEPSRPHLIIDANNGQVLKQWEGLNHAEANGPGGNAKTGKYVYGTDYGPLIVTSDCKMDSGNVATVNLNGGTSGTTPYKFACPTNTYKAINGAYSPLNDAHYFGNVVFNLYKDWFNLKPINQKLLMKVHYSRNYENAFWDGTAMTFGDGASTFYPLVSLDVSAHEVSHGFTEQNSGLVYDGQSGGINEAFSDMAGEAAEYYMKGKNDFLVGAEIFKKTGALRYFADPTKDGQSIGNAKDYYDGLDVHYSSGVYNKAFYLIATSPNWNTRKAFEVFVDANRLYWTANATYNSAACGVVKAADARGYNSADVTKAFTAVGVTCK

SEQ ID NO: 4 - DNA, 552 bp, Chromobacterium subtsugae
  source 1..552: mol_type = genomic DNA
atgtctttgactaccgattttctggagaacccgcaggctttcatgcgttctcaggcgatattgattccggcgcaggttccgcccggcaacggcaaataccagttcgcggcgcagggcgcgcacgcggcggtgctgcagtccaccgccgccagcccgaacatccccggtttttacgcgcatccggtggccaacaacatcaatctgttcgtgctgcccacccagcagccggcaaggtattacatgttcaccgacggcatgaacggctgccagtttctggcctacgggccggacaggcagcacatcaccgtcgagcacaacaacttcatcggcgacccgacgcgctacgcggcgcggctggcggaggtggtggcgctgaagccggcctatctgctgcatatcagcccgtcgggggtcaataacatcccggccggccaatacaacagccagcagggggtgaacatcgtcggcgaatacggccaggccaacggctggcgcttctgggtgcgggacagggtggaccagaaccagggcacggtgtacgggccgctgtaa

SEQ ID NO: 5 - DNA, 1095 bp, Chromobacterium subtsugae
  source 1..1095: mol_type = genomic DNA
atggacaagagattgccagccgtggccgcggctttgctgttggcggcttccgccgctcacgccggcgacctgcaggtcagcctggggcagccggtggtcagcgcgggtcaggacgttgacgtcgctttgacttaccgcaataccggcaaggagaccttgcacgtgtaccgctggttcgtgcccggcaaggaactgcaggagcagtttctggcggtgaatgtgaacggcaagccggccgagtacctgggcccgcgctacaagcgcgtggtgccgtcgctgcgcgacaccgtggcgctggcgcccggcgccacgctgaacgccaaggtgagggtgtccgagtattacgacctgtccaagccgggccagctgagcgtccgttttgaaagcagcagcaacaaggtgctcaaccgcagcctgccggccggcgtcaatgccaagcaggcggccgcgccgcaggccgacgaggccatttcctccaatgtggtgggcgcctacagcgccggcagcgtcagccccttgctgaccaagtccaaggcggccaagcaggagtggcaggtgctcagccgcagcgcggtcagcggcgtcagctacgccggcaattgctcggtcagccagcagtcgcaatcgcgcgacggcgtgctggccgccagcgccatggccagcgaaacggcggcctacctggccggcacgccgtccggcacgccgcgcttcaccacttggttcggcaagtacagccaggccaactggaccaccgccaagtcgcattacgtcaacatcaaggatgcgctggacagcaagccgatcaagctggattgcagctgcaccgacggcggcacttatgcctacgtctatccggggcagccgtacaccgtctatctgtgcggcgctttctggaccgcgccgaccaagggcaccgactccaagggcggcaccctggtgcatgagttgtcgcacttcaccgtggtggcgggcacccaggaccatgtctatggccaggccggcgccaagagcctggccaagagcaacccggcccaggccttggacaatgccgacaaccatgaatacttcgccgagaacaccccggcgcagcagtaa

SEQ ID NO: 6 - DNA, 1470 bp, Chromobacterium subtsugae
  source 1..1470: mol_type = genomic DNA
atgagaaaacagcaattgatgttgcgtggtttggtcctgtccgccctggctgtgttcagctcggcggcgctggcggccgagcgtatcgacctggaaaagctgggcaagatccaggccaacggcgcggtggcgttcaccggcgtgaaccaggctgatctgaagcccctgcgcagcacccaattcgccaccggcaaagtggtgacccgcttccagcagtactaccagggcgtgccggtatggggcgaagccgtggtcgaggaaaaacaggccggcgccgtggccaagaccagcggcaaactatccggccaatacatcgccggcatccagtccgacctggcttccgccaagccgacgttgagcagcgcccaggcgttgagccaggccaaatcgctgaaggccaacggcaatcccacctacaacgagaaagccgacctagtggtgcgcctgaacgagcgcaacaccgcccagctggtctacctagtgtccttcgtggtcgacggcaaggagcccagccgcccgcacctgatcatcgacgccaacaacggccaggtgctgaagcagtgggaaggcctgaaccacgccgaagccaacggccccggcggcaacgccaagaccggcaagtatgtctacggcaccgactacggtccgctgatcgtcaccagcgattgcaagatggatagcggcaacgtcgccaccgtcaacctcaacggcggcaccagcggcaccaccccgtacaagttcgcctgcccgaccaacacctacaaagcgatcaacggcgcttactcgccgctgaacgacgcgcactacttcggcaacgtggtgttcaacctgtacaaggactggttcaacctgaagccgatcaaccagaagctgctgatgaaggtgcactacagccgcaactacgaaaacgcgttctgggacggcaccgcgatgaccttcggcgacggcgccagcaccttctacccgctggtgtcgctggacgtgtccgcgcatgaagtcagccacggcttcaccgagcagaactccggcctggtctacgacggccagtccggcggcatcaacgaggcattctccgacatggccggcgaagccgccgagtactacatgaagggcaagaacgacttcctggtgggcgcggaaatcttcaagaagaccggcgcgctgcgctacttcgccgatccgaccaaggacggccaatcgatcggcaacgccaaggactactacgacggcctggacgtgcactattccagcggcgtgtacaacaaggccttttacctgatcgccaccagcccgaactggaacacccgcaaggcgtttgaagtgttcgtcgacgccaaccggctgtactggaccgccaacgccacctacaacagcgccgcttgcggcgtggtcaaggcggccgacgcccgcggctacaacagcgccgacgtcaccaaggccttcaccgcagtcggcgtgacttgcaaataa

(19) United States
(12) Patent Application Publication
(10) Pub. No.: US 2025/0287954 A1
(43) Pub. Date: Sep. 18, 2025

(54) METHOD AND COMPOSITION OF SYNERGISTIC INSECTICIDAL MIXTURES

(71) Applicant: PRO FARM GROUP, INC., Davis, CA (US)

(72) Inventors: Ratnakar N. Asolkar, Davis, CA (US); Walter Ramirez, Elk Grove, CA (US); Scott Burman, Woodland, CA (US)

(21) Appl. No.: 18/861,172

(22) PCT Filed: Apr. 28, 2023
(86) PCT No.: PCT/US2023/066380

§ 371 Date: Oct. 28, 2024

Related U.S. Application Data
(60) Provisional application No. 63/336,021, filed on Apr. 28, 2022.

(51) Int. Cl. A01N 63/50; A01N 63/20; A01P 7/04

(52) U.S. Cl. CPC A01N 63/50; A01N 63/20; A01P 7/04

(57) ABSTRACT

The present disclosure provides a synergistic insecticidal composition comprising: one or more chromamide compounds; and one or more Scott proteins disposed in a carrier.

### PRIORITY

This application claims priority to U.S. provisional application No. 63/336,021, filed Apr. 28, 2022.

### TECHNICAL FIELD OF THE DISCLOSURE

The present disclosure relates in general to the field of bioactive compositions and metabolites derived from Chromobacterium for controlling pests, as well as their methods of use to control pests.

### STATEMENT OF FEDERALLY FUNDED RESEARCH

None.

### INCORPORATION-BY-REFERENCE OF MATERIALS FILED ON COMPACT DISC

None.

### BACKGROUND

Without limiting the scope of the disclosure, its background is described in connection with a synergistic bioactive compositions and metabolites derived from Chromobacterium for controlling pests, as well as their methods of use to control pests.

Natural products are substances produced by microbes, plants, and other organisms. Microbial natural products offer an abundant source of chemical diversity, and there is a long history of utilizing natural products for pharmaceutical purposes. Despite the emphasis on natural products for human therapeutics, where more than 50% are derived from natural products, only 11% of pesticides are derived from natural sources. Nevertheless, natural product pesticides have potential to play an important role in controlling pests in both conventional and organic farms. Secondary metabolites produced by microbes (bacteria, actinomycetes and fungi) provide novel chemical compounds which can be used either alone or in combination with known compounds to effectively control insect pests and to reduce the risk for resistance development. There are several well-known examples of microbial natural products that are successful as agricultural insecticides (Thompson et al., 2000; Arena et al., 1995; Krieg et al. 1983).

The development of a microbial pesticide starts with the isolation of a microbe in a pure culture. It then proceeds with efficacy and spectrum screening using in vitro, in vivo or pilot scale trials in a greenhouse and in the field. At the same time, active compounds produced by the microbe are isolated and identified. For the commercialization of a microbial pesticide, the microbe has to be economically produced by fermentation at an industrial scale and formulated with biocompatible and approved additives to increase efficacy and to maximize the case of application as well as storage stability under field conditions.

In 2000, Dr. Martin and her coworkers at USDA isolated a purple-pigmented bacteria (PRAA4-1) from a forest soil in Maryland (Martin et al., 2007a). In the initial screening, they found this bacteria to be toxic to Colorado potato beetle and other insect pests (Martin et al., 2007b). This motile, Gram-negative bacteria was identified as a new species of Chromobacteria, Chromobacterium substsugae sp. nov (Martin et al., 2007c). It is a facultatively aerobic, motile, Gram-negative betaproteobacterium with polar flagella. Colonies formed at 2-3 days on an L-agar plate at 25° C. are initially cream colored, gradually turning light to dark violet during the following 24 hours. Colonies of PRAA4-1 grow well on peptone based media with an optimum at 25° C., pH 6.5-8.0, and with 0-1.5% (w/v) NaCl (Martin et al., 2007a).

Since the finding of C. substugae by Martin and her coworkers, at least three new species of Chromobacteria have been isolated, and characterized; Young et al. (2008) isolated a novel Chromobacterium species, C. aquaticum, from spring water samples in Taiwan, and Kampfer et al. (2009) isolated two species, C. piscinae and C. pseudoviolaceum, from environmental samples collected in Malaysia.

Of all known species of Chromobacteria, C. violaceum, is a gram-negative known species Chromobacteria, and is a common inhabitant of soil and water in tropical and subtropical regions. Published information on secondary metabolites produced by Chromobacteria is based on studies on C. violaceum only (see, for example, Duràn and Menck (2001) for a comprehensive review of the pharmacological and industrial perspectives of C. violaceum). It is normally considered nonpathogenic to humans, but as an opportunistic pathogen, it has occasionally been the causative agent for septicemia and fatal infections in humans and animals. C. violaceum is known to produce a purple pigment, violacein, which is a bisindole molecule generated by a fusion of two L-tryptophan molecules in the presence of oxygen (Hoshino et al., 1987; Ryan and Drennan; 2009). Violacein biosynthesis is regulated by quorum-sensing, a common mechanism regulating various other secondary metabolism pathways in Gram-negative bacteria (McClean et al., 1997).

Other known metabolites of C. violaceum summarized by Duràn and Menck (2001) include hydrogen cyanide, ferrioxamine E, B-lactamic glycopeptides SQ28,504 and SQ28,546, antibiotics such as aerocyanidin, acrocavin, 3,6-dihydroxy-indoxazene, and monobactam SB-26.180, and an antitumoral depsipeptide FR901228. According to the review article by Duran and Menck (2001), C. violaceum also produces unusual sugar compounds such as extracellular polysaccharides and lipopolysaccharides.

U.S. Pat. No. 8,715,754, which is incorporated herein in its entirety by reference, also discloses compounds obtainable or derived from Chromobacterium species, more particularly, Chromobacterium substugae.

U.S. Pat. No. 9,259,007, which is incorporated herein in its entirety by reference, discloses a stabilized biological pesticides comprising Chromobacterium species, filtrate, supernatant, extract or pesticidally active substance derived therefrom with pesticidal activity having improved shelf life due to maintenance of physical uniformity and longer insecticide activity after use due to higher resistance to degradation when exposed to sunlight.

### SUMMARY OF THE DISCLOSURE

The present disclosure provides a synergistic insecticidal composition comprising: (a) one or more chromamide compounds; (b) violacein; and (c) one or more proteins selected from Scott 1, Scott 2 and Scott 3 disposed in a carrier. According to one aspect, the one or more chromamide compounds of the composition comprise chromamide with a MW 860, a MW 874A, a MW 874B, and MW 876. In another configuration the chromamide compounds comprise one or more selected from chromamide A with a MW 860 (Molecular weight 860), chromamide with a MW 874A (Molecular weight 874), chromamide with a MW 874B (molecular weight 874), and chromamide with a MW 876 (Molecular weight 876).

The present disclosure provides a synergistic insecticidal composition comprising: one or more chromamide compounds; and one or more Scott proteins disposed in a carrier.

The present disclosure also provides a method for modulating infestation of a pest comprising: applying an amount of compound effective for modulating said infestation comprising one or more chromamide compounds; and one or more Scott proteins disposed in a carrier to a location where modulation is desired. The one or more chromamide compounds comprise one or more chromamide with a molecular weight of 860, molecular weight of 874A, molecular weight of 874B, and molecular weight of 876. The composition further comprises one or more additional insecticides. The pest is selected from an Acari, Muscidae, Drosophilidae, Anthomyidae, Aphididae, TrioZidae, Tenebrionidae, and Scarabacidae.

The present disclosure also provides a method for modulating infestation of a pest, wherein said pest is selected from an Acari, Muscidae, Drosophilidae, Anthomyidae, Aphididae, TrioZidae, Tenebrionidae, and Scarabacidae, in a location where modulation is desired comprising the step of applying an amount of a comprising: (a) one or more chromamide compounds selected from chromamide A (MW 860), chromamide MW 874A, chromamide MW 874B, and chromamide MW 876; and (b) one or more Scott proteins (one or more proteins selected from Scott 1, Scott 2 and Scott 3) disposed in a carrier, effective for modulating said infestation. The location where modulation is desired is on a plant, plant seed or in soil. In one configuration the pest is an Acari and the Acari is a mite. In one configuration the pest is selected from a Tetranychus sp. a Musca sp., Myzus sp., Bactericera sp., Cyclo cephala sp., Alphitobius sp., Drosophila sp., Delia sp., Rhizotrogus sp., Popillia sp., Anomala sp., and Otiorhynchus Sp. In one configuration the pest comprises Musca domesitcas, Drosophila suzuki, Delia radicum, Myzus persicae, Bactericera cockerelli, Alphitobius diaperinus xi, Cyclocephala lurida, Rhizotrogus maialis, Popilla japonica, Otiorhynchus sulcatus, or Anomala orientalis. In one configuration the composition comprises supernatant, filtrate, or extract from the whole cell broth.

### BRIEF DESCRIPTION OF THE DRAWINGS

For a more complete understanding of the features and advantages of the present disclosure, reference is now made to the detailed description of the disclosure along with the accompanying figures and in which:

FIG. 1 is a schematic representation of purification scheme for obtaining chromamide Aviolacein (2) and deoxyviolacein (3). from culture broth.

FIG. 2 depicts chemical structures for chromamide A (1) violacein (2) and deoxyviolacein (3).

FIG. 3 is a graph of the percent mortality for the samples.

FIG. 4 is a graph of the activity while holding chromamides constant while varying scott1 and a graph of varying chromamides while holding scott1 constant.

FIG. 5 is a graph of the cabbage looper bioassay.

FIG. 6 a plot of an insecticidal bioassay results for various purified compound with and without Sct1.

FIG. 7 a plot of the effect of variation of concentration of MW 860 & Sct1 on insecticidal activity.

### DETAILED DESCRIPTION OF THE DISCLOSURE

As defined herein, “derived from” means directly isolated or obtained from a particular source or alternatively having identifying characteristics of a substance or organism isolated or obtained from a particular source.

A “carrier” as defined herein is an inert, organic or inorganic material, with which the active ingredient is mixed or formulated to facilitate its application to plant or other object to be treated, or its storage, transport and/or handling.

The term “modulate” as defined herein is used to mean to alter the amount of pest infestation or rate of spread of pest infestation.

The term “pest infestation” as defined herein, is the presence of a pest in an amount that causes a harmful effect including a disease or infection in a host population or emergence of an undesired weed in a growth system.

A “pesticide” as defined herein, is a substance derived from a biological product or chemical substance that increase mortality or inhibit the growth rate of plant pests and includes but is not limited to nematocides, insecticides, herbicides, plant fungicides, plant bactericides, and plant viricides.

A “biological pesticide” as defined herein is a microorganism with pesticidal properties.

As defined herein, “whole broth culture” refers to a liquid culture containing both cells and media. If bacteria are grown on a plate the cells can be harvested in water or other liquid, whole culture.

The term “supernatant” refers to the liquid remaining when cells grown in broth or are harvested in another liquid from an agar plate and are removed by centrifugation, filtration, sedimentation, or other means well known in the art.

A defined herein, “filtrate” refers to liquid from a whole broth culture that has passed through a membrane.

As defined herein, “extract” refers to liquid substance removed from cells by a solvent (water, detergent, buffer) and separated from the cells by centrifugation, filtration or other method.

As used herein, “MBI-203” means any microbial-based insecticide containing Chromobacterium subtsugae and spent fermentation media as an active ingredient.

Chromamide compounds are compounds with molecular weight of 860, and their homolog, including but not limited to 874A, 874B & 876 and with structure described herein, that can be obtained by (a) culturing a strain of Chromobacterium substugae in a culture medium or whole cell broth under conditions sufficient to produce said compound and (b) isolating said compound produced from the whole cell broth of (a).

“Scott protein” and “Sct proteins” are defined herein as the nucleotide sequence (SEQ ID 4, 5, 6) or the protein sequence as shown in Seq ID No 1, 2, or 3 and listed as Scott1 (Scott 1, Sct1), Scott2 (Scott 2, Sct2) or Scott3 (Scott 3, Sct3).

| | | | | Amino | |
|---|---|---|---|---|---|
| Protein | | Apparent MW | | Acid | |
| name | Function | (SDS-PAGE) | Nucleotide sequences | Sequences | Homology |
| Scott1 | | ~20 kDa | >fig\|6666666.22288.peg.2223[MBI-203 | MSLTTDFLENPQA | Extracellular, |
| | | | sp.] [hypothetical protein] | FMRSQAILIPAQVP | Secreted. |
| | | | atgtctttgactaccgattttctggagaacccgcaggctttca | PGNGKYQFAAQG | |
| | | | tgcgttctcaggcgatattgattccggcgcaggttccgccc | AHAAVLQSTAASP | |
| | | | ggcaacggcaaataccagttcgcggcgcagggcgcgca | NIPGFYAHPVANN | |
| | | | cgcggcggtgctgcagtccaccgccgccagcccgaaca | INLFVLPTQQPAR | |
| | | | tccccggtttttacgcgcatccggtggccaacaacatcaat | YYMFTDGMNGCQ | |
| | | | ctgttcgtgctgcccacccagcagccggcaaggtattacat | FLAYGPDRQHITV | |
| | | | gttcaccgacggcatgaacggctgccagtttctggcctac | EHNNFIGDPTRYA | |
| | | | gggccggacaggcagcacatcaccgtcgagcacaacaa | ARLAEVVALKPA | |
| | | | cttcatcggcgacccgacgcgctacgcggcgcggctggc | YLLHISPSGVNNIP | |
| | | | ggaggtggtggcgctgaagccggcctatctgctgcatatc | AGQYNSQQGVNI | |
| | | | agcccgtcgggggtcaataacatcccggccggccaatac | VGEYGQANGWRF | |
| | | | aacagccagcagggggtgaacatcgtcggcgaatacgg | WVRDRVDQNQGT | |
| | | | ccaggccaacggctggcgcttctgggtgcgggacagggt | VYGPL | |
| | | | ggaccagaaccagggcacggtgtacgggccgctgtaa | (SEQ ID NO: 1) | |
| | | | (SEQ ID NO: 4) | | |
| Scott2 | Protease | ~20 kDa | >fig\|6666666.22288.peg.3563 [MBI-203 | MDKRLPAVAAAL | Protease BLASTp |
| | | | sp.] [probable protease precursor] | LLAASAAHAGDL | C. violaceum |
| | | | atggacaagagattgccagccgtggccgcggctttgctgt | QVSLGQPVVSAGQ | M35 peptidase |
| | | | tggcggcttccgccgctcacgccggcgacctgcaggtca | DVDVALTYRNTG | domain, Lysine- |
| | | | gcctggggcagccggtggtcagcgcgggtcaggacgtt | KETLHVYRWFVP | specific metallo- |
| | | | gacgtcgctttgacttaccgcaataccggcaaggagacctt | GKELQEQFLAVNV | endopeptidase, |
| | | | gcacgtgtaccgctggttcgtgcccggcaaggaactgca | NGKPAEYLGPRYK | Zn binding |
| | | | ggagcagtttctggcggtgaatgtgaacggcaagccggc | RVVPSLRDTVALA | domain. |
| | | | cgagtacctgggcccgcgctacaagcgcgtggtgccgtc | PGATLNAKVRVSE | |
| | | | gctgcgcgacaccgtggcgctggcgcccggcgccacgc | YYDLSKPGQLSVR | |
| | | | tgaacgccaaggtgagggtgtccgagtattacgacctgtc | FESSSNKVLNRSLP | |
| | | | caagccgggccagctgagcgtccgttttgaaagcagcag | AGVNAKQAAAPQ | |
| | | | caacaaggtgctcaaccgcagcctgccggccggcgtcaa | ADEAISSNVVGAY | |
| | | | tgccaagcaggcggccgcgccgcaggccgacgaggcc | SAGSVSPLLTKSK | |
| | | | atttcctccaatgtggtgggcgcctacagcgccggcagcg | AAKQEWQVLSRS | |
| | | | tcagccccttgctgaccaagtccaaggcggccaagcagg | AVSGVSYAGNCS | |
| | | | agtggcaggtgctcagccgcagcgcggtcagcggcgtc | VSQQSQSRDGVLA | |
| | | | agctacgccggcaattgctcggtcagccagcagtcgcaat | ASAMASETAAYL | |
| | | | cgcgcgacggcgtgctggccgccagcgccatggccagc | AGTPSGTPRFTTW | |
| | | | gaaacggcggcctacctggccggcacgccgtccggcac | FGKYSQANWTTA | |
| | | | gccgcgcttcaccacttggttcggcaagtacagccaggcc | KSHYVNIKDALDS | |
| | | | aactggaccaccgccaagtcgcattacgtcaacatcaagg | KPIKLDCSCTDGG | |
| | | | atgcgctggacagcaagccgatcaagctggattgcagct | TYAYVYPGQPYT | |
| | | | gcaccgacggcggcacttatgcctacgtctatccggggca | VYLCGAFWTAPT | |
| | | | gccgtacaccgtctatctgtgcggcgctttctggaccgcgc | KGTDSKGGTL VHE | |
| | | | cgaccaagggcaccgactccaagggcggcaccctggtg | LSHFTVVAGTQDH | |
| | | | catgagttgtcgcacttcaccgtggtgggggcacccagg | VYGQAGAKSLAK | |
| | | | accatgtctatggccaggccggcgccaagagcctggcca | SNPAQALDNADN | |
| | | | agagcaacccggcccaggccttggacaatgccgacaac | HEYFAENTPAQQ | |
| | | | catgaatacttcgccgagaacaccccggcgcagcagtaa | (SEQ ID NO: 2) | |
| | | | (SEQ ID NO: 5) | | |
| Scott3 | Metalloprotease | ~34 kDa | >fig\|6666666.22288.peg.175 [MBI-203 | MRKQQLMLRGLV | Class IV |
| | | | sp.] [Vibriolysin, extracellular zinc | LSALAVESSAALA | metalloprotease; |
| | | | protease (EC 3.4.24.25) @ Pseudolysin, | AERIDLEKLGKIQ | vibriolysin, |
| | | | extracellular zinc protease (EC 3.4.24.26)] | ANGAVAFTGVNQ | pseudolysin |
| | | | atgagaaaacagcaattgatgttgcgtggtttggtcctgtcc | ADLKPLRSTQFAT | Extracellular, |
| | | | gccctggctgtgttcagctcggcggcgctggcggccgag | GKVVTRFQQYYQ | Zinc protease |
| | | | cgtatcgacctggaaaagctgggcaagatccaggccaac | GVPVWGEAVVEE | |
| | | | ggcgcggtggcgttcaccggcgtgaaccaggctgatctg | KQAGAVAKTSGK | |
| | | | aagcccctgcgcagcacccaattcgccaccggcaaagtg | LSGQYIAGIQSDLA | |
| | | | gtgacccgcttccagcagtactaccagggcgtgccggtat | SAKPTLSSAQALS | |
| | | | ggggcgaagccgtggtcgaggaaaaacaggccggcgc | QAKSLKANGNPT | |
| | | | cgtggccaagaccagcggcaaactatccggccaatacat | YNEKADLVVRLN | |
| | | | cgccggcatccagtccgacctggcttccgccaagccgac | ERNTAQLVYLVSF | |
| | | | gttgagcagcgcccaggcgttgagccaggccaaatcgct | VVDGKEPSRPHLII | |
| | | | gaaggccaacggcaatcccacctacaacgagaaagccg | DANNGQVLKQWE | |
| | | | acctagtggtgcgcctgaacgagcgcaacaccgcccagc | GLNHAEANGPGG | |
| | | | tggtctacctagtgtccttcgtggtcgacggcaaggagccc | NAKTGKYVYGTD | |
| | | | agccgcccgcacctgatcatcgacgccaacaacggcca | YGPLIVTSDCKMD | |
| | | | ggtgctgaagcagtgggaaggcctgaaccacgccgaag | SGNVATVNLNGG | |
| | | | ccaacggccccggcggcaacgccaagaccggcaagtat | TSGTTPYKFACPT | |
| | | | gtctacggcaccgactacggtccgctgatcgtcaccagcg | NTYKAINGAYSPL | |
| | | | attgcaagatggatagcggcaacgtcgccaccgtcaacct | NDAHYFGNVVFN | |
| | | | caacggcggcaccagcggcaccaccccgtacaagttcg | LYKDWFNLKPINQ | |
| | | | cctgcccgaccaacacctacaaagcgatcaacggcgctt | KLLMKVHYSRNY | |
| | | | actcgccgctgaacgacgcgcactacttcggcaacgtggt | ENAFWDGTAMTF | |
| | | | gttcaacctgtacaaggactggttcaacctgaagccgatca | GDGASTFYPLVSL | |
| | | | accagaagctgctgatgaaggtgcactacagccgcaact | DVSAHEVSHGFTE | |
| | | | acgaaaacgcgttctgggacggcaccgcgatgaccttcg | QNSGLVYDGQSG | |
| | | | gcgacggcgccagcaccttctacccgctggtgtcgctgg | GINEAFSDMAGEA | |
| | | | acgtgtccgcgcatgaagtcagccacggcttcaccgagc | AEYYMKGKNDFL | |
| | | | agaactccggcctggtctacgacggccagtccggcggca | VGAEIFKKTGALR | |
| | | | tcaacgaggcattctccgacatggccggcgaagccgccg | YFADPTKDGQSIG | |
| | | | agtactacatgaagggcaagaacgacttcctggtgggcg | NAKDYYDGLDVH | |
| | | | cggaaatcttcaagaagaccggcgcgctgcgctacttcgc | YSSGVYNKAFYLI | |
| | | | cgatccgaccaaggacggccaatcgatcggcaacgcca | ATSPNWNTRKAFE | |
| | | | aggactactacgacggcctggacgtgcactattccagcgg | VFVDANRLYWTA | |
| | | | cgtgtacaacaaggccttttacctgatcgccaccagcccg | NATYNSAACGVV | |
| | | | aactggaacacccgcaaggcgtttgaagtgttcgtcgacg | KAADARGYNSAD | |
| | | | ccaaccggctgtactggaccgccaacgccacctacaaca | VTKAFTAVGVTC | |
| | | | gcgccgcttgcggcgtggtcaaggcggccgacgcccgc | K (SEQ ID NO: 3) | |
| | | | ggctacaacagcgccgacgtcaccaaggccttcaccgca | | |
| | | | gtcggcgtgacttgcaaataa (SEQ ID NO: 6) | | |

The present disclosure relates to synergistic insecticidal mixtures comprising at least one of: chromamide A (MW 860), MW 874A, MW 874B, MW 876, and one or more proteins selected from Scott 1, Scott 2 and Scott 3 and to their related compositions and methods of controlling insects. In some configurations the composition also includes one or more additional insecticides. The insecticides include but is not limited to pyrethrins, spirotetramet and organochlorines.

The present disclosure also relates to a method for synergistic control of insects by contacting the insect or their food supply with a synergistically effective amount of a combination of a) chromamide A MW 860, MW 874A, MW 874B, MW 876, and b) one or more proteins selected from Scott 1, Scott 2 and Scott 3.

Furthermore, this disclosure also relates to a process for preparing a synergistic insecticidal composition containing above compounds.

Previous in-house studies have shown that the insecticidal activity present in MBI-203 whole cell broth is mainly attributed to the synergy between secondary metabolites (chromamide analogues) and protein (Scott 1, Scott 2 and/or Scott 3). However, these studies were carried out using mixed chromamides (a mixture of four analogues) and Sct1.

The disclosure also relates to a method of protecting plants from attack or infestation by insects comprising contacting the plant, or the soil or water in which the plant is growing, with a synergistically effective amount of a combination of above compounds.

As used herein the term chromamide A (MW 860) having a molecular weight of 860 has the structure below and includes the synthetic composition.

As used herein the term chromamide A (MW 874A) having a molecular weight of 874 has the structure below and includes the synthetic composition.

As used herein the term chromamide A (MW 874B) having a molecular weight of 874 has the structure below and includes the synthetic composition.

As used herein the term chromamide A (MW 876) having a molecular weight of 876 has the structure below and includes the synthetic composition.

In one configuration, the metabolite may be a compound that (a) has pesticidal activity; (b) has a molecular weight of about 840-900 as determined by Liquid Chromatography/Mass Spectroscopy (LC/MS) and (c) has an High Pressure Liquid Chromatography (HPLC) retention time of about 7-12 minutes on a reversed phase C-18 HPLC column using a water:acetonitrile (CH₃CN) gradient solvent system (0-20 min; 90-0% aqueous CH₃CN, 20-24 min; 100% CH₃CN, 24-27 min; 0-90% aqueous CH₃CN, 27-30 min; 90% aqueous CH₃CN) at 0.5 mL/min flow rate and UV detection of 210 nm and (d) is optionally obtainable from a Chromobacterium species. The compound in one configuration may be a peptide.

In a particular configuration, the compound has 43 carbons, seven methyl, ten methylene carbons, twelve methines, 6 olefinic methines, and eight quaternary carbons as determined by 13C NMR. In more particular configurations, the compound encompasses compounds “A”, “B”, “C”, “D”, depicted as ##STR001 #. ##STR001a ##, ##STR001b ##, ##STR001c ##respectively.

In one specific configuration, the compound “A”: (a) is obtainable from a Chromobacterium species; (b) is toxic to a pest; (c) has a molecular weight of about 840-890 and more particularly, 860 as determined by Liquid chromatography/Mass Spectroscopy (LC/MS); (d) has 1H NMR values of δ 8.89, 8.44, 8.24, 8.23, 7.96, 7.63, 6.66, 5.42, 5.36, 5.31, 5.10, 4.13, 4.07, 4.05, 3.96, 3.95, 3.88, 3.77, 3.73, 3.51, 3.44, 3.17, 2.40, 2.27, 2.11, 2.08, 2.03, 2.01, 1.97, 1.95, 1.90, 1.81, 1.68, 1.63, 1.57, 1.53, 1.48, 1.43, 1.35, 1.24, 1.07, 1.02, 0.96, 0.89, 0.88, 0.87, 0.80 and has 13C NMR values of δ 173.62, 172.92, 172.25, 172.17, 171.66, 171.28, 170.45, 132.13, 130.04, 129.98, 129.69, 129.69, 125.48, 98.05, 70.11, 69.75, 68.30, 68.25, 64.34, 60.94, 54.54, 52.82, 49.72, 48.57, 45.68, 40.38, 39.90, 38.18, 36.60, 31.98, 31.62, 31.58, 29.53, 28.83, 27.78, 24.41, 23.06, 22.09, 20.56, 19.31, 18.78, 17.66, 15.80 (e) has an High Pressure Liquid Chromatography (HPLC) retention time of about 7-12 minutes, more specifically about 9 minutes and even more specifically about 9.08 min on a reversed phase C-18 HPLC (Phenomenex, Luna 5μ C18 (2) 100 A, 100×4.60 mm) column using a water:acetonitrile (CH₃CN) with a gradient solvent system (0-20 min; 90-0% aqueous CH₃CN, 20-24 min; 100% CH₃CN, 24-27 min; 0-90% aqueous CH₃CN, 27-30 min; 90% aqueous CH₃CN) at 0.5 mL/min flow rate and UV detection of 210 nm.

In another specific configuration, the compound “B” has the following characteristics: (a) is obtainable from a Chromobacterium species; (b) is toxic to a pest; (c) has a molecular weight of about 850-900 and more particularly, 874 as determined by Liquid Chromatography/Mass Spectroscopy (LC/MS); (d) has an High Pressure Liquid Chromatography (HPLC) retention time of about 7-12 minutes, more specifically about 9 minutes and even more specifically about 9.54 min on a reversed phase C-18 HPLC (Phenomenex, Luna 5u C18 (2) 100 A, 100×4.60 mm) column using a water:acetonitrile (CH₃CN) with a gradient solvent system (0-20 min; 90-0% aqueous CH₃CN, 20-24 min; 100% CH₃CN, 24-27 min; 0-90% aqueous CH₃CN, 27-30 min; 90% aqueous CH₃CN) at 0.5 mL/min flow rate and UV detection of 210 nm.

The metabolite may also be a compound including but not limited to:

### A Compound Having the Structure ##STR001 ##

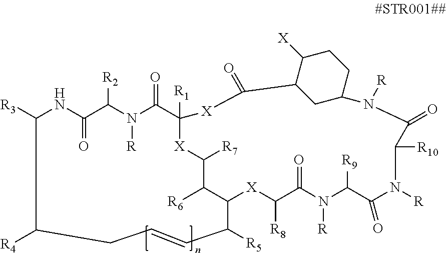

or a pesticidally acceptable salt or stereoisomers thereof, wherein R is —H, lower chain alkyl containing 1, 2, 3, 4, 5, 6, 7, 8 or 9 alkyl moieties, aryl or arylalkyl moiety, substituted lower alkyl; X is O, NH, NR or S; n is 0, 1, 2, 3, 4, 5, 6, 7, 8 or 9; R1, R2, R3, R4, R5, R6, R7, R8, R9, R10, R11 are each independently H, are the same or different and independently an amino acid side-chain moiety or an amino acid side-chain derivative, alkyl, substituted alkyl, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl;

### (B) a Compound Having the Structure ##STR001a ##

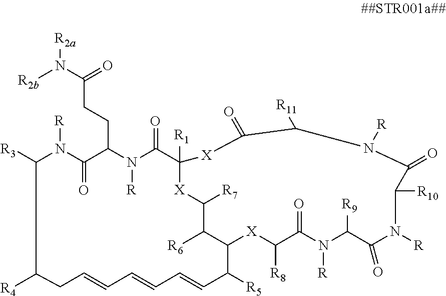

wherein R is —H, lower chain alkyl containing 1, 2, 3, 4, 5, 6, 7, 8 or 9 alkyl moieties, aryl or arylalkyl moiety, substituted lower alkyl; X is O, NH, NR or S; R2a, R2b are independently selected from the group consisting of —H, alkyl, lower-alkyl, substituted alkyl and substituted lower-alkyl; R1, R2, R3, R4, R5, R6, R7, R8, R9, R10, R11 are each independently H, are the same or different and independently an amino acid side-chain moiety or an amino acid side-chain derivative, alkyl, substituted alkyl, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl.

### (C) a Compound Having the Structure ##STR001b ##

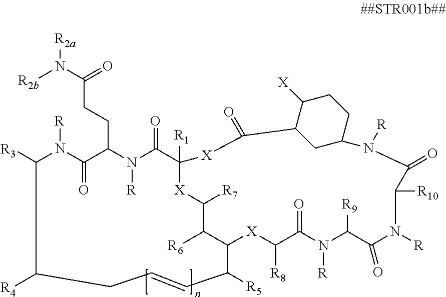

wherein R is —H, lower chain alkyl containing 1, 2, 3, 4, 5, 6, 7, 8 or 9 alkyl moieties, aryl or aryl alkyl moiety, substituted lower alkyl; X is O, NH, NR or S; n is 0, 1, 2, 3, 4, 5, 6, 7, 8 or 9; R2a, R2b are independently selected from the group consisting of —H, alkyl, lower-alkyl, substituted alkyl and substituted lower-alkyl; R1, R2, R3, R4, R5, R6, R7, R8, R9, R10, R11 are each independently H, are the same or different and independently an amino acid side-chain moiety or an amino acid side-chain derivative, alkyl, substituted alkyl, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O) H, acyl, oxyacyl, carbamate, sulfonyl, sulfonamide, or sulfuryl.

### (D) a Compound Having the Structure ##STR001c ##

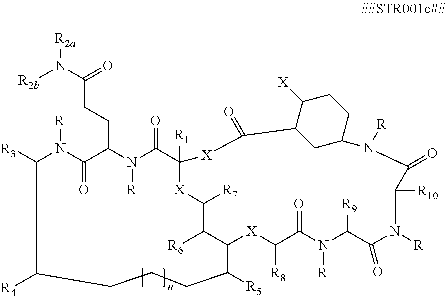

wherein R is —H, lower chain alkyl, aryl or aryl alkyl moiety, substituted lower alkyl containing 1, 2, 3, 4, 5, 6, 7, 8 or 9 alkyl moieties; X is O, NH, NR or S; n is 0, 1, 2, 3, 4, 5, 6, 7, 8 or 9; R2a, R2b are independently selected from the group consisting of —H, alkyl, lower-alkyl, substituted alkyl and substituted lower-alkyl; R1, R2, R3, R4, R5, R6, R7, R8, R9, R10, R11 are each independently H, are the same or different and independently an amino acid side-chain moiety or an amino acid side-chain derivative, alkyl, substituted alkyl, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl.

In a more particular configuration, the metabolite is chromamide A (1).

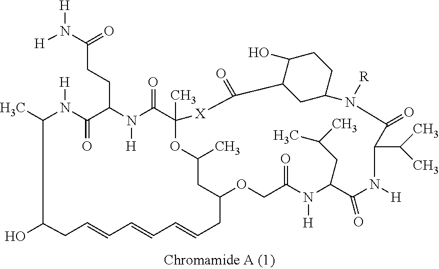

In a particular configuration, the metabolite is compound “C”, has the following characteristics: (a) is obtainable from a Chromobacterium species; (b) is toxic to one or more pests; (c) has a molecular weight of about 325-360 and more particularly, about 343 as determined by Liquid Chromatography/Mass Spectroscopy (LC/MS); (d) has an High Pressure Liquid Chromatography (HPLC) retention time of about 8-14 minutes, more specifically about 10 minutes and even more specifically about 10.88 min on a reversed phase C-18 HPLC (Phenomenex, Luna 5/t C18 (2) 100 A, 100×4.60 mm) column using a water:acetonitrile (CH₃CN) with a gradient solvent system (0-20 min; 90-0% aqueous CH₃CN, 20-24 min; 100% CH₃CN, 24-27 min; 0-90% aqueous CH₃CN, 27-30 min; 90% aqueous CH₃CN) at 0.5 mL/min flow rate and UV detection of 210 nm. In a particular configuration, compound “C” may be violacein (2), a known compound isolated earlier from Chromobacterium violaceum.

In another configuration, another metabolite used in the compositions and methods set forth above, is the compound “D”, has the following characteristics: (a) is obtainable from a Chromobacterium species; (b) is toxic to a pest; (c) has a molecular weight of about 315-350 and more particularly, about 327 as determined by Liquid Chromatography/Mass Spectroscopy (LC/MS); (d) has an High Pressure Liquid Chromatography (HPLC) retention time of about 10-15 minutes, more specifically about 12 minutes and even more specifically about 12.69 min on a reversed phase C-18 HPLC (Phenomenex, Luna 5μ C18 (2) 100 A, 100×4.60 mm) column using a water:acetonitrile (CH₃CN) with a gradient solvent system (0-20 min; 90-0% aqueous CH₃CN, 20-24 min; 100% CH₃CN, 24-27 min; 0-90% aqueous CH₃CN, 27-30 min; 90% aqueous CH₃CN) at 0.5 mL/min flow rate and UV detection of 210 nm. In a particular configuration, compound “D” may be characterized as deoxyviolacein (3), a known compound isolated earlier from Chromobacterium violaceum.

In another specific configuration, the compound may have the following structure:

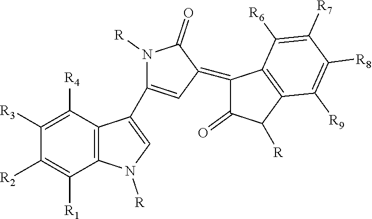

wherein R is —H, lower chain alkyl containing 1, 2, 3, 4, 5, 6, 7, 8 or 9 alkyl moieties, aryl or aryl alkyl moiety, substituted lower alkyl, halogens; R1, R2, R3, R4, R5, R6, R7, R8, R9 are each independently H, are the same or different, alkyl, substituted alkyl, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl.

Further provided is a method for (1) modulating pest (e.g., nematode, insect, soil-borne bacteria) infestation in a plant comprising applying to the plant and/or seeds thereof and/or substrate used for growing said plant or a method for modulating soil borne bacteria in soil comprising applying to the plant, seeds, and/or substrate an amount of a Compound that (a) has pesticidal and/or antimicrobial activity; (b) has a molecular weight of about 950-1450 as determined by LTQ Orbitrap XL hybrid Fourier Transform Mass Spectrometer. (c) has 1H NMR δ values of 5.22 (sext, 1H), 2.62 (dd, 1H), 2.53 (dd, 1H), and 1.31 (d, 3H) (d) has 13C NMR δ values of 169.2, 67.6, 40.9, and 19.8. (d) comprises the structure -(—O—CHCH₃—CH₂—CO—)ₙ—, where n=6-50 (e) is obtainable from a Chromobacterium species and (II) Optionally Another Pesticidal Substance effective to modulate infestation in said plant.

Compound (I) may have the structure:

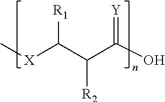

Wherein X, is independently —O, —NR, or —S, wherein R is H or C1-C10 alkyl; Y, is independently —O, —S; n=6-50; R1, R2 are each independently H, alkyl, substituted alkyl, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl.

In particular, the compound (I) has the structure:

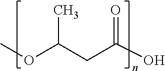

wherein n=10-25. In a most specific configuration, (I) is an alpha-butyric acid.

Further provided is a method for obtaining the compounds set forth above. The method comprises culturing a strain of a Chromobacterium sp. in a whole cell broth under conditions sufficient to produce the compound and isolating the compound produced from the whole cell broth.

In a related aspect, disclosed are methods for stabilizing biological pesticide compositions against physical separation and loss of activity due to exposure to sunlight by applying an amount of a stabilizing agent to said biological pesticide composition effective to stabilize the biological pesticide composition against physical separation and loss of activity due to exposure to sunlight. Also provided are compositions comprising such agents. In a particular configuration, the pesticidal composition comprises Chromobacterium sp. filtrate, supernatant, extract or pesticidally active substance derived therefrom which may be present in the amount of at least about 0.5% and particularly between about 0.5 wt % based on dry cell weight to about 30 wt. %. The stabilizing agent may in a particular configuration be a benzoic acid salt and/or lignin salt, particularly lignin sulfonate salt, including but not limited to sodium, potassium, calcium, magnesium, ammonium, and combinations thereof and may present in the amount of at least about 2.5 wt % and may preferably be present in the amount of about 5%-15%.

The substances set forth above used in the compositions and methods disclosed herein can be formulated in any manner. Non-limiting formulation examples include but are not limited to Emulsifiable concentrates (EC), Wettable powders (WP), soluble liquids (SL), Aerosols, Ultra-low volume concentrate solutions (ULV), Soluble powders (SP), Microencapsulation, Water dispersed Granules, Flowables (FL), Microemulsions (ME), Nano-emulsions (NE), etc. In any formulation described herein, percent of the active ingredient is within a range of 0.01% to 99.99%.

The compositions may be in the form of a liquid, gel or solid. Liquid compositions comprise pesticidal compounds derived from a Chromobacterium strain, e.g. a strain having the identifying characteristics of Chromobacterium substugae sp. nov and more particularly, having the identifying characteristics of NRRL B-30655 (see U.S. Pat. No. 7,244,607).

A solid composition can be prepared by suspending a solid carrier in a solution of pesticidal compounds and drying the suspension under mild conditions, such as evaporation at room temperature or vacuum evaporation at 65° C. or lower.

A composition may comprise gel-encapsulated compounds derived from the Chromobacterium strain. Such gel-encapsulated materials can be prepared by mixing a gel-forming agent (e.g., gelatin, cellulose, or lignin) with a culture or suspension of live or inactivated Chromobacterium, or a cell-free filtrate or cell fraction of a Chromobacterium culture or suspension, or a spray- or freeze-dried culture, cell, or cell fraction or in a solution of pesticidal compounds used in the method of the disclosure; and inducing gel formation of the agent.

The composition may additionally comprise a surfactant to be used for the purpose of emulsification, dispersion, wetting, spreading, integration, disintegration control, stabilization of active ingredients, and improvement of fluidity or rust inhibition. In a particular configuration, the surfactant is a non-phytotoxic non-ionic surfactant which preferably belongs to EPA Inerts List 4B. In another particular configuration, the nonionic surfactant is polyoxyethylene (20) monolaurate. The concentration of surfactants may range between 0.1-35% of the total formulation, preferred range is 5-25%. The choice of dispersing and emulsifying agents, such as non-ionic, anionic, amphoteric and cationic dispersing and emulsifying agents, and the amount employed is determined by the nature of the composition and the ability of the agent to facilitate the dispersion of the compositions of the present disclosure.

The composition as set forth above also comprises a stabilizing agent, which stabilizes a biological pesticide composition against physical separation and loss of activity due to exposure to sunlight. This stabilizing agent may be a benzoic acid salt or lignin sulfonate salt.

The composition set forth above may be combined with another microorganism and/or pesticide (e.g, nematocide, fungicide, insecticide, antibiotic or anti-microbial agent). The microorganism may include but is not limited to an agent derived from Bacillus sp., Pseudomonas sp., Brevabacillus sp., Lecanicillium sp., non-Ampelomyces sp., Pseudozyma sp., Streptomyces sp, Burkholderia sp, Trichoderma sp, Gliocladium sp. Alternatively, the agent may be a natural oil or oil-product having fungicidal and/or insecticidal activity (e.g., paraffinic oil, tea tree oil, lemongrass oil, clove oil, cinnamon oil, citrus oil, rosemary oil). Furthermore, the pesticide may be a single site anti-fungal agent which may include but is not limited to benzimidazole, a demethylation inhibitor (DMI) (e.g., imidazole, piperazine, pyrimidine, triazole), morpholine, hydroxypyrimidine, anilinopyrimidine, phosphorothiolate, quinone outside inhibitor, quinoline, dicarboximide, carboximide, phenylamide, anilinopyrimidine, phenylpyrrole, aromatic hydrocarbon, cinnamic acid, hydroxyanilide, antibiotic, polyoxin, acylamine, phthalimide, benzenoid (xylylalanine), a demethylation inhibitor selected from the group consisting of imidazole, piperazine, pyrimidine and triazole (e.g., bitertanol, myclobutanil, penconazole, propiconazole, triadimefon, bromuconazole, cyproconazole, diniconazole, fenbuconazole, hexaconazole, tebuconazole, tetraconazole), myclobutanil, and a quinone outside inhibitor (e.g., strobilurin). The strobilurin may include but is not limited to azoxystrobin, kresoxim-methoyl or trifloxystrobin. In yet another particular configuration, the anti-fungal agent is a quinone, e.g., quinoxyfen (5,7-dichloro-4-quinolyl 4-fluorophenyl ether). The anti-fungal agent may also be derived from a Reynoutria extract.

The fungicide can also be a multi-site non-inorganic, chemical fungicide selected from the group consisting of chloronitrile, quinoxaline, sulphamide, phosphonate, phosphite, dithiocarbamate, chloralkythios, phenylpyridin-amine, cyano-acetamide oxime.

The composition may as noted above, further comprise an insecticide. The insecticide may include but is not limited to avermectin, Bt, neem oil, spinosads, Burkholderdia sp. as set forth in US Patent Application Pub. No. 2011-0207604, entomopathogenic fungi such a Beauveria bassiana and chemical insecticides including but not limited to organochlorine compounds, organophosphorous compounds, carbamates, pyrethroids, and neonicotinoids.

As noted above, the composition may further comprise a nematocide. This nematocide may include but is not limited to avermectin, microbial products such as Biome (Bacillus firmus), Pasteuria spp and organic products such as saponins.

The compositions, cultures and supernatants and pesticidal compounds set forth above may be used as pesticides. In particular, the compounds or compositions as set forth above may be used as insecticides, bactericides (against soil-borne bacteria) and nematocides. Specifically, nematodes that may be controlled using the method set forth above include but are not limited to parasitic nematodes such as root-knot, cyst, and lesion nematodes, including but not limited to Meloidogyne sp. Tylenchorhynchus sp, Hoplolaimus sp., Helicotylenchus sp., Pratylenchus sp., Heterodera sp., Globodera, sp., Trichodorus sp. Paratrichodorus sp., Xiphinema sp., and Criconema sp.; particularly Meloidogyne incognita (root knot nematodes), as well as Globodera rostochiensis and Globodera pailida (potato cyst nematodes); Heterodera glycines (soybean cyst nematode); Heterodera schachtii (beet cyst nematode); and Heterodera avenae (cereal cyst nematode).

As noted above, the active ingredient(s) and compositions set forth above may also be applied to locations containing Acari (arachnids), such as mites, including but not limited to, Panonychus sp. such as Panonychus citri (citrus red mite), and Panonychus ulmi (red spider mite), Tetranychus sp. such as Tetranychus kanzawi (Kanzawa spider mite), Tetranychus urticae (2 spotted spider mite), Tetranychus pacificus (Pacific spider mite), Tetranychus turkestanii (Strawberry mite) and Tetranychus cinnabarinus (Carmine spider mite), Oligonychus sp. such as Oligonychus panicae (avacado brown mite), Oligonychus perseae (persea mite), Oligonychus pratensis (Banks grass mite) and Oligonychus coffeae, Aculus sp. such as Aculus cornatus (Peach silver mite), Aculus fockeni (plum rust mite) and Aculus lycopersici (tomato russet mite), Eotetranychus sp. such as Eotetranychus wilametti, Eotetranychus yumensis (yuma spider mite) and Eotetranychus sexmaculatis (6-spotted mite), Bryobia rubrioculus (brown mite), Epitrimerus pyri (pear rust mite), Phytoptus pyri (Pear leaf blister mite), Acalitis essigi (red berry mite), Polyphagotarsonemus latus (Broad mite), Eriophyes sheldoni (citrus bud mite), Brevipalpus lewisi (citrus flat mite), Phylocoptruta oleivora (citrus rust mite), Petrobia lateens (Brown wheat mite), Oxyenus maxwelli (olive mite), Rhizoglyphus spp., Tyrophagus spp., Diptacus gigantorhyncus (bigheaded plum mite) and Penthaleaa major (winter grain mite), Avocado red mite, Flat mite, black and red Mango spider mite, Papaya leaf edgeroller mite, Texas citrus mite, European red mite, Grape erineum mite (blister mite), Pacific spider mite, Willamette spider mite; Pink citrus rust mite. Such locations may include but are not limited to crops that are infested with such mites or other arachnids (e.g., aphenids). Such locations may include but are not limited to crops that are infested with such mites or other arachnids (e.g., aphenids).

Phytopathogenic insects controlled by the method set forth above include but are not limited to non-Culicidae larvae insects from the order (a) Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; (b) Coleoptera, for example, Agriotes spp., Alphitobius sp., Anomola spp., e.g., Anomala orientalis; Anthonomus spp., Atomaria linearis, Chaetocnema tibialis, Cosmopolites spp., Curculio spp., Cyclocephala spp., e.g., Cyclocephala lurida, Dermestes spp., Diabrotica spp., Epilachna spp., Eremnus spp., Leptinotarsa decemlineata, Lissorhoptrus spp., Melolontha spp., Orycaephilus spp., Otiorhynchus spp., Otiorhynchus sulcatus, Phlyctinus spp., Popillia spp., e.g., Popilla japonica, Psylliodes spp., Rhizopertha spp-, eg., Rhizotrogus majalis, Sitophilus spp., Sitotroga spp., Tenebrio spp., Tribolium spp. and Trogoderma spp.; (c) Orthoptera, for example, Blatta spp., Blattella spp., Gryllotalpa spp., Leucophaea maderae, Locusta spp., Periplaneta spp. and Schistocerca spp.; (d) Isoptera, for example, Reticulitermes spp.; (e) Psocoptera, for example, Liposcelis spp.; (f) Anoplura, for example, Haematopinus spp., Linognathus spp., Pediculus spp., Pemphigus spp. and Phylloxera spp.; (g) Mallophaga, for example, Damalinea spp. and Trichodectes spp.; (h) Thysanoptera, for example, Frankliniella spp., Hercinotnrips spp., Taeniothrips spp., Thrips palmi, Thrips tabaci and Scirtothrips aurantii; (i) Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Tniatoma spp.; (j) Homoptera, for example, Aleurothrixus floccosus, Aleyrodes brassicae, Aonidiella spp., Aphididae, Aphis spp., Aspidiotus spp., Bactericera spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Triozidae spp., Trioza erytreae and Unaspis citri; (k) Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; (1) Diptera, for example, Aedes spp., Antherigona soccata, Bibio hortulanus, Calliphora erythrocephala, Ceratitis spp., Chrysomyia spp., Cuterebra spp., Dacus spp., Delia spp., Delia radicum, Drosophila spp., e.g., Drosophila suzukii; Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; (m) Siphonaptera, for example, Ceratophyllus spp. and Xenopsylla cheopis; (n) from the order Thysanura, for example, Lepisma saccharina; (o) Hemiptera, for example, Bactericera sp., e.g., Bactericera cockerelli.

The active ingredients may be applied to locations containing Scarabaeidae pests. These include but are not limited to soil, grass and various ornamental plants, trees and vegetables.

The active ingredient(s) and compositions set forth above may also be applied to locations containing the Muscidae pest. These include but are not limited to indoor environments, garbage, animals, fences, corrals, barns, milking parlors, farrowing pens etc. containing animals (cattle, pigs, sheep, horses etc.)

The active ingredient(s) and compositions set forth above may further be applied to locations containing the active ingredient(s) and compositions containing a Tenebrionidae pest. These include but are not limited to grains, poultry and poultry dwellings enclosures (fences, corrals, barns, milking parlors, farrowing pens etc.) containing animals (cattle, pigs, sheep, horses etc.)

### Examples

The composition and methods set forth above will be further illustrated in the following, non-limiting examples. The examples are illustrative of various configurations only and do not limit the claimed disclosure regarding the materials, conditions, weight ratios, process parameters and the like recited herein.

Example 1 includes using chromamide A (MW 860), MW 874A, MW 874B, MW 876, violacein, and Scott 1 and to their related compositions and methods of controlling insects.

Example 2 includes chromamide MW 860 and Scott 1, disposed in a carrier, and their related compositions and methods of controlling insects.

Example 3 includes chromamide MW 874A and Scott1, disposed in a carrier, and their related compositions and methods of controlling insects.

Example 4 includes chromamide MW 874B and Scott 1, disposed in a carrier, and their related compositions and methods of controlling insects.

Example 5 includes chromamide MW 876 and Scott 1, disposed in a carrier, and their related compositions and methods of controlling insects.

Example 6 includes using chromamide A (MW 860), MW 874A, MW 874B, MW 876, violacein, and Scott 2 and to their related compositions and methods of controlling insects.

Example 7 includes chromamide MW 860 and Scott2, disposed in a carrier, and their related compositions and methods of controlling insects.

Example 8 includes chromamide MW 874A and Scott2, disposed in a carrier, and their related compositions and methods of controlling insects.

Example 9 includes chromamide MW 874B and Scott2, disposed in a carrier, and their related compositions and methods of controlling insects.

Example 10 includes chromamide MW 876 and Scott2, disposed in a carrier, and their related compositions and methods of controlling insects.

Example 11 includes using chromamide A (MW 860), MW 874A, MW 874B, MW 876, violacein, and Scott 3 and to their related compositions and methods of controlling insects.

Example 12 includes chromamide MW 860 and Scott3, disposed in a carrier, and their related compositions and methods of controlling insects.

Example 13 includes chromamide MW 874A and Scott3, disposed in a carrier, and their related compositions and methods of controlling insects.

Example 14 includes chromamide MW 874B and Scott3, disposed in a carrier, and their related compositions and methods of controlling insects.

Example 15 includes chromamide MW 876 and Scott3, disposed in a carrier, and their related compositions and methods of controlling insects. The following procedure is used for the purification of compounds extracted from the culture of Chromobacterium substugae disclosed in Example 1:

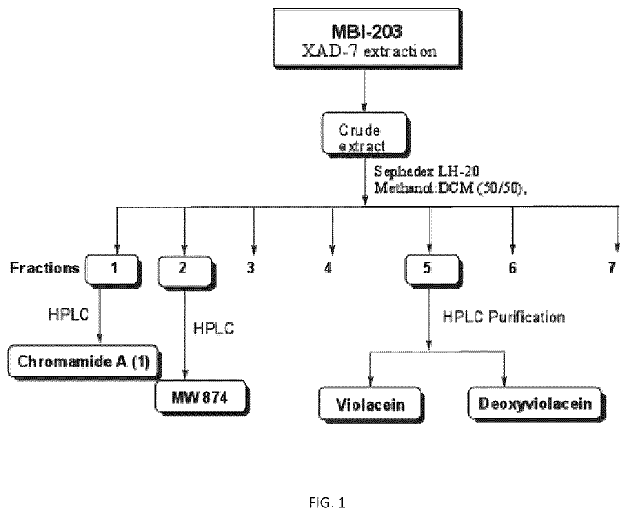

The culture broth derived from the 10-L fermentation C. substugae in L-broth is extracted with Amberlite XAD-7 resin (Asolkar et al., 2006) by shaking the cell suspension with resin at 225 rpm for two hours at room temperature. The resin and cell mass are collected by filtration through cheesecloth and washed with DI water to remove salts. The resin, cell mass, and cheesecloth are then soaked for 2 h in acetone/methanol (50/50) after which the acetone/methanol is filtered and dried under vacuum using rotary evaporator to give the crude extract. The crude extract is then fractionated by using Sephadex LH 20 size exclusion chromatography (CH₂Cl₂/CH₃OH; 50/50) to give 7 fractions (FIG. 1). These fractions are then concentrated to dryness using rotary evaporator and the resulting dry residues are screened for biological activity using a feeding assay with Cabbage looper (Trichoplusia ni) or Beet armyworm (Spodoptera exigua). The active fractions are then subjected to reversed phase HPLC (Spectra System P4000 (Thermo Scientific) to give pure compounds, which are then screened in above mentioned bioassays to locate/identify the active compounds. To confirm the identity of the compound, additional spectroscopic data such as LC/MS and NMR is recorded.

Chromamide A (1) and compound B were obtained from Fraction 1 and 2 respectively, whereas violacein (2) & deoxyviolacein (3) were purified from Fraction 5 obtained from Sephadex LH 20 chromatography.

Purification of chromamide A (1) was performed by using HPLC C-18 column (Phenomenex, Luna 10u C18 (2) 100 A, 250×10), water:acetonitrile gradient solvent system (0-10 min, 80-75% aqueous CH₃CN; 10-45 min, 75-60% aqueous CH₃CN; 45-55 min, 60-50% aqueous CH₃CN; 55-65 min, 50-100% aqueous CH₃CN; 65-70 min, 100% CH₃CN; 55-70 min, 0-80% aqueous CH₃CN) at 2.5 mL/min flow rate and UV detection of 210 nm. The active compound chromamide A (1), has retention time 23.19 min.

Purification of disclosure compound B was performed by using HPLC C-18 column (Phenomenex, Luna 10u C18 (2) 100 A, 250×10), water:acetonitrile gradient solvent system (0-10 min, 80-75% aqueous CH₃CN; 10-45 min, 75-60% aqueous CH₃CN; 45-55 min, 60-50% aqueous CH₃CN; 55-65 min, 50-100% aqueous CH₃CN; 65-70 min, 100% CH₃CN; 55-70 min, 0-80% aqueous CH₃CN) at 2.5 mL/min flow rate and UV detection of 210 nm, the active compound B, retention time 26.39 min.

Purification of violacein (2) and deoxyviolacein (3) was performed by using HPLC C-18 column (Phenomenex, Luna 10u C18 (2) 100 A, 250×10), water:acetonitrile gradient solvent system (0-10 min, 70-60% aqueous CH₃CN; 10-40 min, 60-20% aqueous CH₃CN; 40-60 min, 20-0% aqueous CH₃CN; 60-65 min, 100% CH₃CN; 65-75 min, 0-70% aqueous CH₃CN) at 2.5 mL/min flow rate and UV detection of 210 nm, the active compounds violacein (2), had a retention time 7.86 min and deoxyviolacein (3) retention time 12.45 min.

Mass spectroscopy analysis of active peaks is performed on a Thermo Finnigan LCQ Deca XP Plus electrospray (ESI) instrument using both positive and negative ionization modes in a full scan mode (m/z 100-1500 Da) on a LCQ DECA XPplus Mass Spectrometer (Thermo Electron Corp., San Jose, Calif.). Thermo high performance liquid chromatography (HPLC) instrument equipped with Finnigan Surveyor PDA plus detector, autosampler plus, MS pump and a 4.6 mm×100 mm Luna C18 5μ 100 A column (Phenomenex). The solvent system consisted of water (solvent A) and acetonitrile (solvent B). The mobile phase begins at 10% solvent B and is linearly increased to 100% solvent B over 20 min and then kept for 4 min, and finally returned to 10% solvent B over 3 min and kept for 3 min. The flow rate is 0.5 mL/min. The injection volume was 10 μL and the samples are kept at room temperature in an auto sampler. The compounds are analyzed by LC-MS utilizing the LC and reversed phase chromatography. Mass spectroscopy analysis of the present compounds is performed under the following conditions: The flow rate of the nitrogen gas was fixed at 30 and 15 arb for the sheath and aux/sweep gas flow rate, respectively. Electrospray ionization was performed with a spray voltage set at 5000 V and a capillary voltage at 35.0 V. The capillary temperature was set at 400° C. The data was analyzed on Xcalibur software. The chromamide A (1) has a molecular mass of 860 in positive ionization mode. The LC-MS chromatogram for another active compound B suggests a molecular mass of 874 in positive ionization mode. Violacein (2) and deoxyviolacein (3) had the molecular masses of 313 and 327 respectively in positive ionization mode.

Extraction of Violacein and Oligo-((1-Hydroxybutyric Acid) from Chromobacterium substugae. The following procedure was used for the purification of compounds extracted from the culture of Chromobacterium substugae:

The whole culture broth (WCB) derived from the 20-L fermentation C. substugae in L-broth was extracted by liquid-liquid extraction method using ethyl acetate. The ethyl acetate layer was separated and dried under vacuum using rotary evaporator to give the crude extract. The crude extract was then fractionated by using different solvent such as dichloromethane (DCM), ethyl acetate (EA), methanol (MeOH) and washing with mixture of solvent (WASH). These fractions were then concentrated to dryness using rotary evaporator and the resulting dry residues are screened for biological activity using different pest (insects, nematodes). The active fractions were then subjected to Sephadex LH 20 size exclusion chromatography (CH₂Cl₂/CH₃OH; 50/50) to give 10 fractions. These fractions were then concentrated to dryness using rotary evaporator and the resulting dry residues (fractions) were screened for biological activity using insect repellency assay with green peach aphids, progeny production of green peach aphid (GPA) and nematicidal bioassay (M. incognita and/or M. hapla). The active fractions were then subjected to reversed phase HPLC (Spectra System P4000 (Thermo Scientific) to give pure compounds, which were then screened in above mentioned bioassays to locate/identify the active compounds. To confirm the identity of the compound, additional spectroscopic data such as LC/MS and NMR were recorded.

In order to identify the compounds responsible for the observed insecticidal activity in MBI-203 (Chromobacterium subtsugae), a bioassay guided fractionation/purification was followed. However, it was found that the insecticidal activity was loss after extraction/fractionation process. The individual fraction/compounds were very weak actives compared to original MBI203 WCB (whole cell broth). However, when these separated compounds were mixed together, this mixture showed similar level of insecticidal activity.

| | | | Uncorrected | Uncorrected |
|---|---|---|---|---|
| | Day 4 | | Mortality | Mortality |
| Sample ID | LC50 | CLKU | @ 8% | @ 32% |
| WCB | 1.24 | 41636 | 100.00 | 100.00 |
| FB | 21.89 | 2354 | 10.00 | 75.00 |
| sct1 intermediate | 954525.61 | 0 | 10.00 | 5.00 |
| FB + sct1 intermediate | 7.53 | 6845 | 45.00 | 100.00 |
| FA + FB + sct1 | 13.04 | 3950 | 20.00 | 100.00 |
| intermediate | | | | |
| CE | 20.76 | 2482 | 15.00 | 70.00 |
| 203-170426C10 (STD) | 4.68 | N/A | 5 | 85 |

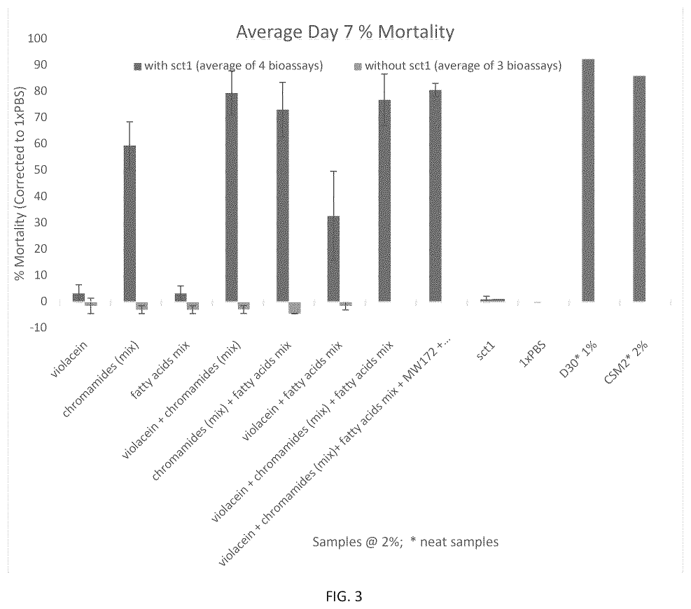

The initial results from testing of the fractions containing Chromamides (mix) and protein (intermediate scott1) showed increased in insecticidal activity compared to individual compounds. Further testing was performed using fractions containing only chromamides (having a molecular weight MW of 860, 874A, 874B and 876) and scott1 (protein) showed comparable activity to that of MBI-203 WCB. FIG. 3 is a graph of the percent mortality for the samples. These results confirmed that the activity between these compounds is the result of synergy between these two classes of compounds. All compounds were tested at 2% rate based on the concentration of each compound present in the MBI-203 WCB.

| | % Mortality (Cabbage Looper | |
|---|---|---|
| | Assay) | |
| | with sct1 | without sct1 |
| | (average of 4 | (average of 3 |
| Sample Description | bioassays) | bioassays) |
| violacein | 3.269104084 | −1.515151515 |
| chromamides (Mix) | 59.45734519 | −2.964426877 |
| fatty acids mix | 3.314393939 | −2.964426877 |
| violacein + chromamides (Mix) | 79.43428854 | −2.898550725 |
| chromamides (mix) + fatty acids mix | 73.1354696 | −4.41370224 |
| violacein + fatty acids mix | 32.66692547 | −1.515151515 |
| violacein + chromamides (mix) + | 76.82453416 | |
| fatty acids mix | | |
| violacein + chromamides (mix) + | 80.50889328 | |
| fatty acids mix + MW172 + crotonic | | |
| acid + 3-hydroxybutyric acid | | |
| sct1 | 1.086956522 | 1.086956522 |
| 1 × PBS* | 0 | 0 |
| D30* 1% | 92.2 | 92.2 |
| CSM2* 2% | 85.81 | 85.81 |

*= neat sample

Insecticidal bioassay: Activity against Cabbage Loopers was tested on Diet Overlay Bioassays. The appropriate artificial insect diet was dispensed into each well of a standard 96 well plate and allowed to dry. Once the diet solidified, 100 μL of the treatment was pipetted into the appropriate number of wells and allowed to dry. A single 1st instar larva was delivered into each well of a 96 well plate. Mortality was scored at 4 days after treatment.

Efficacy is expressed as percentage mortality at 4 days post treatment. Results (in duplicates) in % mortality are shown in above Table/chart.

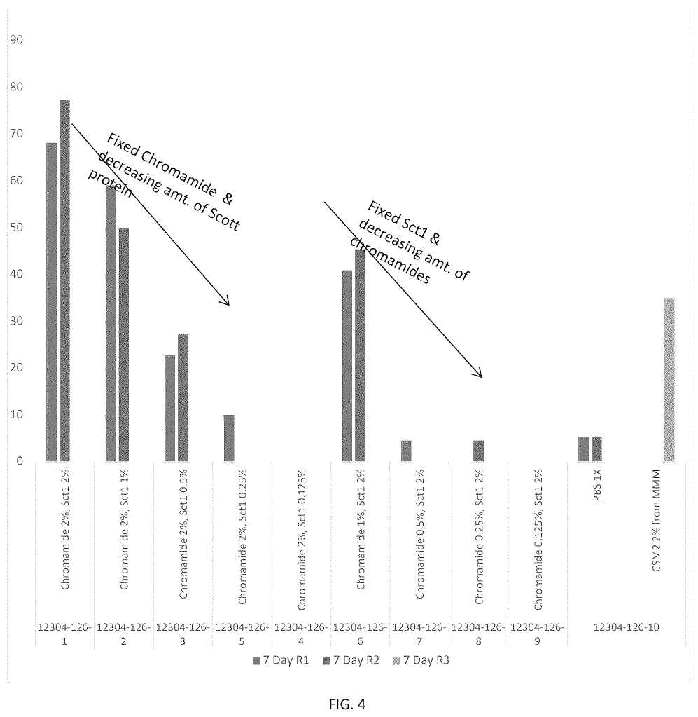

Determination of contribution of chromamides mix & scott1 towards insecticidal activity. FIG. 4 is a graph of the activity while holding chromamides constant while varying scott1 and a graph of varying chromamides while holding scott1 constant.

In order to understand the importance and ratios of these two classes of compounds towards synergy, in one experiment, the concentration of chromamides mix were kept constant and the concentration of scott1 was decrease, while in other experiment, the concentration of scott1 was kept constant and the concentration of chromamides mix was decrease. The insecticidal results showed repaid loss in insecticidal activity when the concentration of chromamides mix was decrease, suggesting concentration of chromamides mix is very importance for the synergy.

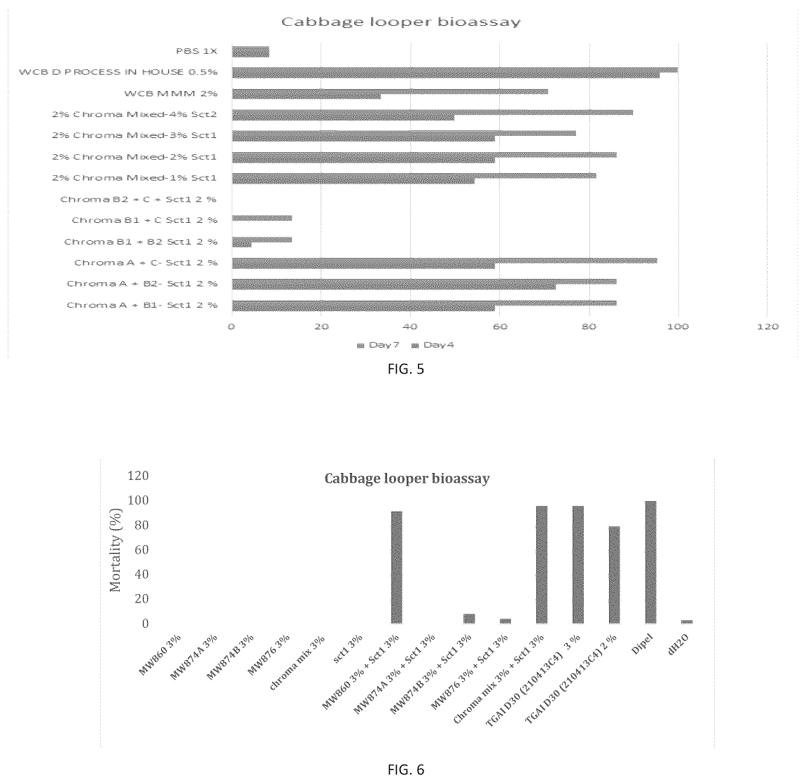

Further experiments using pure chromamides analogues such as MW 860 (Chromamide A), MW 874A, MW 874B, & MW 876 and scott1 were performed. The results from these experiments confirmed chromamide A (MW 860) was very important for the synergy with scott1 protein. The other experiment also confirmed that increasing the concentration of scott1 with chromamides mix did not increase the insecticidal activity. FIG. 5 is a graph of the cabbage looper bioassay.

It is contemplated that any configuration discussed in this specification can be implemented with respect to any method, kit, reagent, or composition of the disclosure, and vice versa. Furthermore, compositions of the disclosure can be used to achieve methods of the disclosure.

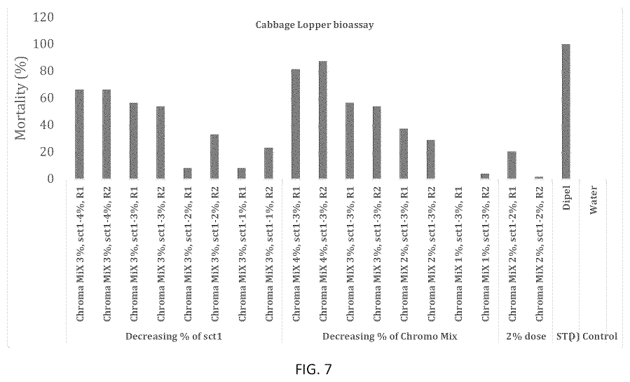

FIG. 6 a plot of an insecticidal bioassay results for various purified compound with and without Sct1. Previous studies have shown that the insecticidal activity present in MBI-203 whole cell broth is mainly attributed to the synergy between secondary metabolites (chromamide analogues) and protein (Sct1). However, for these studies were carried out using mixed chromamides (a mixture of four analogues) and Sct1. With an objective to determine which chromamide analogue is critical for the observed synergy, these individual compounds were purified from MBI-203 WCB, and tested as mixture and individual compounds using the chewing bioassay. All compounds were tested at 3% rate based on the concentration of each present in the MBI-203 WCB. “Chroma mix” contained the chromamides MW 860, MW 874A, MW 874B, and MW 876. As expected, the pure chromamide analogues as well as Sct1 did not show any significant activity when tested individually (FIG. 6). Results from two subsequent testing using Cabbage looper (CL) bioassay, showed MW 860 in combination with Sct1 with 92% mortality at 3% dose, while other analogues had very little to no activity. Thus, based on these results MW 860 and Sct1 can be used as a marker for predicting the insecticidal activity of MBI-203.

Determination of LC50 value for MW 860 & Sct1. Based on the results from the above testing of purified compounds with & without Sct1, the LC50 for the MW 860, Chromamides MIX and Sct1 was determined. The individual pure compound and their mix were combined with Sct1 and submitted for determining the LC50 value. Based on the results from three individual submission, the LC50 for MW860 & Sct1 mixture was found to be between 1.5 to 2.5 ug/mL. Table shows LC50 results for purified compound MW 860 & Sct1.

| Sample ID | LC₅₀ |
|---|---|
| Chroma MIX | 0 |
| Sct1 | 0 |
| Chroma MIX + Sct1 | 1.71 |
| MW 860 | 0 |
| MW 860 + Sct1 | 2.3 |
| TGAI (D30) | 1.25 |
| Positive Control (MBI-203-EP) | 2.05 |

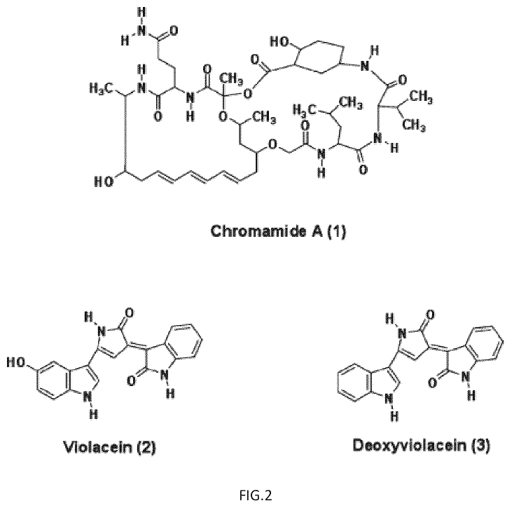

FIG. 7 a plot of the effect of variation of concentration of MW 860 & Sct1 on insecticidal activity. Dose dependent study for MW 860 & Sct1 as mixture. To determine the minimum range of concentration of both MW 860 and Sct1 needed for good insecticidal activity, different ratios of both compounds were prepared and submitted for insecticidal bioassay. Based on bioassay results, increasing concentration of MW 860 showed increased in insecticidal activity, and a minimum of 3% of both MW 860 & Sct-1 are needed to get a control of around 80% (FIG. 2).

It will be understood that particular configurations described herein are shown by way of illustration and not as limitations of the disclosure. The principal features of this disclosure can be employed in various configurations without departing from the scope of the disclosure. Those skilled in the art will recognize, or be able to ascertain using no more than routine experimentation, numerous equivalents to the specific procedures described herein. Such equivalents within the scope of this disclosure and are covered by the claims.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

While the making and using of various configurations of the present disclosure are discussed in detail below, it should be appreciated that the present disclosure provides many applicable inventive concepts that can be embodied in a wide variety of specific contexts. The specific configurations discussed herein are merely illustrative of specific ways to make and use the disclosure and do not delimit the scope of the disclosure.

To facilitate the understanding of this disclosure, a number of terms are defined below. Terms defined herein have meanings as commonly understood by a person of ordinary skill in the areas relevant to the present disclosure. Terms such as “a”, “an” and “the” are not intended to refer to only a singular entity, but include the general class of which a specific example may be used for illustration. The terminology herein is used to describe specific configurations of the disclosure, but their usage does not delimit the disclosure, except as outlined in the claims.

Where a range of values is provided, it is understood that each intervening value, to the tenth of the unit of the lower limit unless the context clearly dictates otherwise, between the upper and lower limit of that range and any other stated or intervening value in that stated range, is included therein. Smaller ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

It must be noted that as used herein and in the appended claims, the singular forms “a,” “and” and “the” include plural references unless the context clearly dictates otherwise.

All the compositions and/or methods disclosed and claimed herein can be made and executed without undue experimentation in light of the present disclosure. While the compositions and methods of this disclosure have been described in terms of preferred configurations, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

### REFERENCES

Asolkar, R. N., Jensen, P. R., Kauffman, C. A., Fenical, W. 2006. Daryamides A-C, Weakly Cytotoxic Polyketides from a Marine-Derived Actinomycete of the Genus Streptomyces strain CNQ-085 J. Nat. Prod. 69:1756-1759.
Martin, P. A. W., D. Gundersen-Rindal, et al. (2007a). “Chromobacterium substugae sp. nov., a betaproteobacterium toxic to Colorado potato beetle and other insect pests.” Int. J. Syst. Evol. Microbiol. 57: 993-999.
Martin, P. A., A. D. S. Shropshire, et al., (2007b). “Chromobacterium substugae sp. nov for control of insect pests” U.S. Pat. No. 7,244,607 B2.
Martin, P. A. W., Hirose, E., and Aldrich, J. R. 2007c. “Toxicity of Chromobacterium substugae to southern green stink bug (Heteroptera: Pentatomidae) and corn rootworm (Coleoptera: Chrysomelidae)”. J. Econ. Entomol. 100:680-684.

What is claimed is:

1. A synergistic insecticidal composition comprising:
(a) one or more chromamide compounds selected from chromamide compositions with a molecular weight of 860, a molecular weight of 874A, MW 874B, and MW 876; and
(b) Scott protein defined by SEQ. ID. NO. 1, the synergistic insecticidal composition disposed in a carrier.

2. The synergistic insecticidal composition according to claim 1 wherein the one or more chromamide compounds comprises a Chromamide A.

3. (canceled)

4. The synergistic insecticidal composition according to claim 1, further comprising an insecticide.

5. The synergistic insecticidal composition of claim 1, wherein the one or more chromamide compounds are synthetic compounds.

6. The synergistic insecticidal composition according to claim 1, wherein the composition comprises supernatant, filtrate, or extract from the whole cell broth.

7. A synergistic insecticidal composition comprising a compound having the following structure, or a salt or stereoisomer thereof, 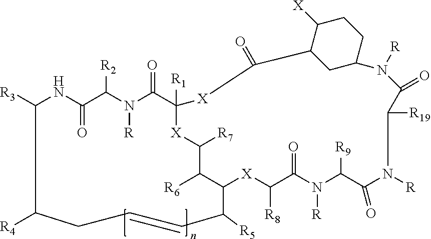
wherein R is —H, a lower chain alkyl containing 1, 2, 3, 4, 5, 6, 7, 8 or 9 alkyl moieties, an aryl or arylalkyl moiety, or a substituted lower alkyl; X is O, NH, NR or S; n is 0, 1, 2, 3, 4, 5, 6, 7, 8 or 9; R1, R2, R3, R4, R5, R6, R7, R8, R9, R10, R11 are the same or different and independently —H, an amino acid side-chain moiety, an amino acid side-chain derivative, an alkyl, a substituted alkyl, an alkenyl, a substituted alkenyl, an alkynyl, a substituted alkynyl, an aryl, a substituted aryl, a heteroaryl, a substituted heteroaryl, a heterocyclic compound, a substituted heterocyclic compound, a cycloalkyl, a substituted cycloalkyl, an alkoxy, a substituted alkoxy, a thioalkyl, a substituted thioalkyl, a hydroxy, a halogen, an amino, an amido, a carboxyl, —C(O)H, an acyl, an oxyacyl, a carbamate, a sulfonyl, a sulfonamide, and/or sulfuryl.

8. A method for modulating infestation of a pest comprising: applying an amount of compound effective for modulating said infestation comprising one or more chromamide compounds; and one or more Scott proteins, the one or more Scott proteins selected from Scott 1 SEQ. ID. NO. 1, Scott 2 SEQ ID. NO. 2 and Scott 3 SEQ. ID. NO 2, disposed in a carrier to a location where modulation is desired.

9. The method according to claim 8, wherein the one or more chromamide compounds comprise:
one or more chromamide with a molecular weight of 860, molecular weight of 874A, molecular weight of 874B, and molecular weight of 876.

10. The method according to claim 8, wherein said pest is selected from an Acari, Muscidae, Drosophilidae, Anthomyidae, Aphididae, TrioZidae, Tenebrionidae, and Scarabaeidae.

11. The method according to claim 8, wherein said pest is an Acari and the Acari is a mite.

12. The method according to claim 11, wherein said mite is a Tetranychus sp.

13. The method of claim 12, wherein the Tetranychus sp. is Tetranychus urticae.

14. The method according to claim 8, wherein the one or more one or more Scott proteins is selected from Scott 1 SEQ. ID. NO. 1, Scott 2 SEQ. ID. NO. 2 and Scott 3 SEQ. ID. NO. 3.

15. The composition-method according to claim 8, wherein the composition further comprises one or more additional insecticides.

16. The method according to claim 8, wherein the location where modulation is desired is on a plant, plant seed or in soil.

17. The method according to claim 8, wherein said pest is selected from a Musca sp., Myzus sp., Bactericera sp., Cyclocephala sp., Alphitobius sp., Drosophila sp., Delia sp., Rhizotrogus sp., Popillia sp., Anomala sp., Myzus sp., Musca sp., and Otiorhynchus Sp.

18. The method of claim 7, wherein the pest is a Scarabaeidae larva.

19. The method of claim 8, wherein the one or more chromamide compounds comprises Chromamide A; and wherein the one or more Scott proteins comprises the Scott protein by SEQ. ID. NO. 1.
